(19) United States
(12) Patent Application Publication
(10) Pub. No.: US 2014/0286292 A1
(43) Pub. Date: Sep. 25, 2014

(54) E-PDCCH MAPPING, AND METHOD AND APPARATUS FOR TRANSMISSION AND RECEPTION IN WIRELESS COMMUNICATION SYSTEM

(71) Applicant: PANTECH CO., LTD., Seoul (KR)

(72) Inventor: Kyoungmin Park, Seoul (KR)

(21) Appl. No.: 14/356,354

(22) PCT Filed: Oct. 16, 2012
(86) PCT No.: PCT/KR2012/008440

§ 371 Date: May 5, 2014

(30) Foreign Application Priority Data
Nov. 7, 2011 (KR) 10-2011-0115151

(51) Int. Cl. H04L 5/00; H04L 1/00

(52) U.S. Cl. CPC H04L 5/0032; H04L 1/0038; H04L 1/001
USPC 370/329

(57) ABSTRACT

The present invention relates to E-PDCCH (Extended PDCCH) mapping, and a method and an apparatus for transmission and reception in a wireless communication system. The E-PDCCH mapping and the transmission method according to one embodiment of the present description, includes the steps of: enabling a base station to perform distributed resource allocation for two or more regions to which the E-PDCCH is transmitted; and mapping the E-PDCCH to be transmitted to a user terminal by applying a mapping rule to resources of one or more regions among the two or more regions. The mapping rule includes at least one of a first mapping rule for mapping the E-PDCCH to a resource within a pre-indicated region in the terminal, and a second mapping rule for mapping the E-PDCCH according to an aggregation level of the E-PDCCH.

### CROSS-REFERENCE TO RELATED APPLICATIONS

This application is the National Stage of International Application PCT/KR2012/008440, filed on Oct. 16, 2012, and claims priority from and the benefit of Korean Patent Application No. 10-2011-0115151, filed on Nov. 7, 2011, all of which are hereby incorporated by reference for all purposes as if fully set forth herein.

### BACKGROUND

1. Field

The present invention relates to a method and apparatus for securing reception of an E-PDCCH, and more particularly, to a method of mapping an E-PDCCH, a method of reducing decoding delay, and an apparatus implementing the same.

2. Discussion of the Background

Various technologies have been considered to increase a data transmission rate in a wireless communication system. For example, technologies such as Multiple Input Multiple Output (MIMO), Carrier Aggregation (CA), a Coordinated Multiple Point (CoMP), a Relay node, and the like have been considered to improve a data transmission rate. To use the described technologies, a transmitting end is required to transmit a larger amount of control information to a user equipment.

Currently, a scheme that transmits control information to a wireless resource in which data as opposed to control information is transmitted has been proposed, to transmit a larger amount of control information. However, when the control information is transmitted in the wireless resource as opposed to in a transmission region of the control information, the control information may not be quickly utilized.

### SUMMARY

The present specification executes resource mapping in the state in which distributed resource allocation is used, so as to support E-PDCCH transmission appropriately for a channel state of each user equipment, and limits the size of a search space where a user equipment determines the E-PDCCH, so as to reduce complexity of the blind detection of the user equipment. This may reduce decoding delay of the E-PDCCH and thus, the efficiency of transmission of the E-PDCCH may be improved.

In accordance with an aspect of the present invention, there is provided an E-PDCCH (Extended PDCCH) mapping and transmitting method, the method including: executing, by a base station, distributed resource allocation with respect to two or more regions in which an E-PDCCH is to be transmitted; and applying a mapping rule to a resource of one or more regions of the two or more regions, so as to map the E-PDCCH to be transmitted to a user equipment, wherein the mapping rule includes one or more mapping rules among a first mapping rule that maps the E-PDCCH to a resource in a region that is indicated in advance to the user equipment through a high layer signaling, and a second mapping rule that maps the E-PDCCH based on an aggregation level of the E-PDCCH.

In accordance with another aspect of the present invention, there is provided an E-PDCCH (Extended PDCCH) receiving method, the method including: receiving, by a user equipment from a base station, a wireless signal including an EPDCCH; and executing blind detection of the received wireless signal in one or more regions of two or more regions to which distributed-resource allocation is executed, based on a detection rule, wherein the detection rule includes one or more detection rules among a first detection rule that executes blind detection using, as a search space, a region that is indicated by the base station in advance through a high layer signaling, and a second detection rule that executes blind detection by changing a search space based on an aggregation level of an E-PDCCH.

In accordance with another aspect of the present invention, there is provided an E-PDCCH (Extended PDCCH mapping and transmitting apparatus, the apparatus comprising: a controller that executes distributed resource allocation with respect to two or more regions in which an E-PDCCH is to be transmitted; a mapping unit that applies a mapping rule to a resource of one or more regions of the two or more regions, so as to map the E-PDCCH to be transmitted to a user equipment; and a transceiving unit that transmits a wireless signal including the E-PDCCH, wherein the mapping rule includes one or more mapping rules among a first mapping rule that maps the E-PDCCH to a resource in a region indicated in advance to the user equipment through a high layer signaling and a second mapping rule that maps the E-PDCCH based on an aggregation level of the E-PDCCH.

In accordance with another aspect of the present invention, there is provided an E-PDCCH (Extended PDCCH) receiving apparatus, the apparatus including: a transceiving unit that receives, from a base station, a wireless signal including an E-PDCCH; a detection unit that executes, based on a detection rule, blind detection of the received wireless signal in one or more regions of two or more regions to which distributed resource allocation is executed; and a controller that controls the transceiving unit and the detection unit, wherein the detection rule includes one or more detection rules among a first detection rule that executes blind detection using, as a search space, a region that is indicated in advance by the base station through a high layer signaling, and a second detection rule that executes blind detection by changing a search space based on the aggregation level of the E-PDCCH.

### BRIEF DESCRIPTION OF DRAWINGS

FIG. 1 is a diagram illustrating a process of resource allocation and transmission of an E-PDCCH, and blind detection of a receiving end according to an embodiment of the present invention;

FIG. 2 illustrates distributed resource allocation and localized resource allocation, which are resource allocation schemes, according to an embodiment of the present invention;

FIG. 3 is a diagram illustrating an E-PDCCH resource mapping scheme according to an embodiment of the present invention;

FIG. 4 illustrates various embodiments of executing blind detection when an E-PDCCH uses a distributed resource allocation scheme according to an embodiment of the present invention;

FIG. 5 is a diagram illustrating three schemes that increase an aggregation level and obtains a frequency diversity gain according to an embodiment of the present invention;

FIG. 6 is a diagram illustrating a blind detection process executed by a UE according to an embodiment of the present invention;

FIG. 7 is a diagram illustrating SDM of E-PDCCH multiplexing according to an embodiment of the present invention;

FIG. 8 is a diagram illustrating TCDM of E-PDCCH multiplexing according to an embodiment of the present invention;

FIG. 9 is a diagram illustrating a region of an E-PDCCH resource according to a first embodiment of the present invention;

FIGS. 10, 11, and 12 are diagrams illustrating an example of changing E-PDCCH mapping based on an aggregation level according to a second embodiment of the present invention;

FIG. 13 is a diagram illustrating an example of executing blind detection when the second embodiment is applied;

FIG. 14 is a diagram illustrating a process executed between a base station and a user equipment, to implement the first embodiment of the present invention;

FIG. 15 is a diagram illustrating a process executed between a base station and a user equipment, to implement the second embodiment of the present invention;

FIG. 16 is a diagram illustrating a process in which a base station maps and transmits an E-PDCCH according to an embodiment of the present invention;

FIG. 17 is a diagram illustrating a process in which a user equipment receives a wireless signal to which an E-PDCCH is mapped, and executes blind detection of the same, according to an embodiment of the present invention;

FIG. 18 is a diagram illustrating a configuration of a base station or an apparatus that is coupled to the base station, for mapping an E-PDCCH to a resource and transmitting a wireless signal, according to an embodiment of the present invention; and

FIG. 19 is a diagram illustrating a configuration of a user equipment or an apparatus that is coupled to the user equipment, for receiving a wireless signal to which an E-PDCCH is mapped.

### DETAILED DESCRIPTION OF THE ILLUSTRATED EMBODIMENTS

Hereinafter, embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

Also, the terminology or word used in the present specifications and claims provided hereinafter should not be limited to a general or dictionary definition, and should be construed to be the meaning and the concept that corresponds with the technical idea of the present invention based on the principle that an inventor may appropriately define the concept of a terminology so as to describe an invention in the best way.

Current mobile communication systems, for example, 3GPP, LTE (Long Term Evolution), LTE-A (LTE-Advanced), and the like, may be high capacity communication systems capable of transmitting and receiving various types of data such as image data, wireless data, and the like, beyond providing a sound-based service. Accordingly, there is a desire for a technology that transmits high capacity data, which is comparable to a wired communication network. Also, the system is required to include an appropriate error detection scheme that minimizes loss of information and increases transmission efficiency of the system so as to enhance performance of the system.

Both a transmitting end and a receiving end may use a communication system that uses a Multiple-Input Multiple-output (hereinafter referred to as “MIMO”), and a single UE (SU) or multiple UEs (MU) may share identical wireless resource capacity through the system, so as to receive or transmit a signal from/to a single base station or the like.

The system that uses MIMO may need a process of recognizing a channel state using various reference signals, standard signals, or the like, and feeding back the recognized result to a transmitting end (another device).

That is, when a single user equipment is allocated with a plurality of downlink physical channels, the user equipment feeds back, to a base station, channel state information associated with each physical channel so as to adaptively optimize the system. To this end, signals such as a channel state indication reference signal (CSI-RS (Channel Status Information-Reference Signal)), and signals of a channel quality indicator (CQI: Channel Quality Indicator) and a precoding matrix index (PMI: Precoding Matrix Index) may be used, and the base station may execute scheduling of a channel based on the channel-state related information. Also, a Cell-specific Reference Signal (CRS) transmitted in the entire downlink subframe may also be transmitted by a base station to user equipments in a corresponding cell. Further, a Sounding Reference Signal (SRS) for determining a channel state of a user equipment and a Demodulation Reference Signal (DM RS) for demodulation may be used. In particular, a CSI-RS is transmitted by a base station, and PMI and CQI are information reported by a user equipment.

The wireless communication system may be widely installed so as to provide various communication services, such as voice data, packet data, and the like, and the wireless communication system may include a User Equipment (UE), a Base Station (BS or eNB), and a unit that assists the actions of the base station such as an RRH (Remote Radio Head) and the like. Throughout the specifications, the user equipment may be an inclusive concept indicating a user terminal utilized in wireless communication, including a UE (User Equipment) in WCDMA, LTE, HSPA, and the like, and an MS (Mobile station), a UT (User Terminal), an SS (Subscriber Station), a wireless device, and the like in GSM.

The base station or a cell may generally refer to a station where communication with the user equipment is performed, and may also be referred to as a Node-B, an eNB (evolved Node-B), a Sector, a Site, a BTS (Base Transceiver System), an Access Point, a Relay Node, an RRH, and the like.

That is, the base station or the cell may be construed as an inclusive concept indicating a portion of an area covered by a BSC (Base Station Controller) in CDMA, a NodeB in WCDMA, an eNB or a sector (site) in LTE, and the like, and the concept may include various coverage areas, such as a megacell, a macrocell, a microcell, a picocell, a femtocell, a communication range of a relay node, and the like.

In the specifications, the user equipment and the base station are used as two inclusive transceiving subjects to embody the technology and technical concepts described in the specifications, and may not be limited to a predetermined term or word. Varied multiple access schemes may be unrestrictedly applied to the wireless communication system. The wireless communication system may utilize varied multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like.

Uplink transmission and downlink transmission may be performed based on a TDD (Time Division Duplex) scheme that performs transmission based on different times, or based on an FDD (Frequency Division Duplex) scheme that performs transmission based on different frequencies.

An embodiment of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. The present invention may not be limited to a specific wireless communication field, and may include all technical fields to which the technical idea of the present invention is applicable.

In LTE, a standard may be developed by forming an uplink and a downlink based on a single carrier or a pair of carriers. The uplink and the downlink may transmit control information through a control channel, such as a PDCCH (Physical Downlink Control CHannel), PCFICH (Physical Control Format Indicator CHannel), PHICH (Physical Hybrid ARQ Indicator CHannel), PUCCH (Physical Uplink Control CHannel), and the like, and may be configured as a data channel, such as PDSCH (Physical Downlink Shared CHannel), PUSCH (Physical Uplink Shared CHannel), and the like, so as to transmit data.

LTE uses a standard based on a single carrier as a base and has discussed coupling of a few bands having a bandwidth of 20 MHz or less, whereas LTE-A has discussed a band of a component carrier having a bandwidth of 20 MHz or more. LTE-A has discussed a multiple Carrier Aggregation (CA) by taking backward compatibility into consideration based on the base standard of LTE. In an uplink and a downlink, five or more component carriers are taken into consideration. The number of component carriers may increase or decrease from the five component carriers based on a system environment, and the present invention may not be limited thereto. Hereinafter, a component carrier aggregation refers to a set formed of two or more component carriers that are configured to be used in a corresponding system.

With respect to a CA, uplink ACK/NACK (ACKnowledgement/Negative ACKnowledgement) transmission and uplink channel information transmission including CQI (Channel Quality Indicator, hereinafter referred to as “CQI”), PMI (Precoding Matrix Indicators, hereinafter referred to as “PMI”), and RI (Rank Indicator, hereinafter referred to as “RI”) are to be taken into consideration among varied matters to be considered in association with designing of a control channel.

In LTE-A, backward compatibility of the 3GPP LTE Rel-8 is basically taken into consideration to form a CA. CQI/PMI/RI information determined to be a standard in LTE Rel-8 may be transmitted based on varied schemes through an uplink control channel such as a PUCCH (Physical Uplink Control Channel) and a PUSCH (Physical Uplink Shared Channel).

The wireless communication system according to an embodiment of the present invention may support an uplink and/or downlink HARQ.

When the number of user equipments increases in a base station, the number of control signals provided to the user equipments may also include and an amount of resources required for transmission of the control signals may increase. The case in which the number of user equipments increases may be classified into a case in which the number of user equipments in a cell managed by a corresponding base station gradually increases, and a case in which the number of user equipments increases using various multiple-transmission schemes. A communication system of the latter may include a coordinated multi-point transmission/reception system in which two or more transmission ends coordinate and transmit a signal, a coordinated multi-antenna transmission system, and a coordinated multi-cell communication system (hereinafter, “coordinated multi-cell communication system” or “CoMP”). Particularly, among the multi-cell communication systems, the communication system may be micro or local base stations (Remote Radio Head, hereinafter referred to as an RRH) in various forms such as a Femto cell, a Pico cell, a Relay, a Hot spot, and the like, located in a cell radius of a single macro base station. A network formed of base stations in various forms is referred to as a heterogeneous network (hereinafter, a Het-Net).

First, an E-PDCCH will be briefly described.

MIMO, CoMP, and Het-Net that have been described above are technologies for improving the performance of a wireless communication system. When the technologies are applied, more control information may be required. However, a resource of a control region may be insufficient to allocate a plurality of PDCCHs for transmitting control information (here, the control region refers to a wireless resource region where a PDCCH is included).

For this reason, to increase control channel capacity of a control channel, a scheme that uses a resource that has been used for transmission of an existing PDSCH, for the transmission of the control information is used so that the control information may be transmitted through a scheduling gain, a beamforming gain, and the like, in the same manner as existing data information. In this manner, a reception reliability of the control information may be increased. Also, in a heterogeneous network, the control information channel capacity may be increased through a scheme of obtaining a spectrum reuse gain.

A PDCCH existing in an existing control region may be newly defined and briefly implemented, or a part of a data region including a PDSCH or the like may be used for the control information. Unlike the configuration of the existing PDCCH, a newly defined PDCCH for transmission of more PDCCHs is referred to as an E-PDCCH (Extended PDCCH). In the present invention, a scheme of transferring control information that is transferred through an existing PDCCH or other channels, through an existing PDSCH or through a band allocated for each user equipment, is commonly designated E-PDCCH. The E-PDCCH may be variously implemented, and the invention provided in the present specifications may not be limited to a specific scheme that implements the E-PDCCH.

The E-PDCCH will be described in detail as follows. That is, a scheme of transmitting control information to a user equipment (UE) using a wireless resource allocated for an existing PDSCH, and a control information channel are commonly designated E-PDCCH. The E-PDCCH dramatically increases the capacity of a control channel. However, control information and data information are received at the same time and thus, a great amount of time may be expended when a user equipment obtains control information. The expenditure of time may cause an increase of delay between data transmission and restoration. Also, unlike the PDCCH, a transmission scheme using a narrow band or a small number of frequency resources is sensitive to frequency selective fading associated with a frequency. To overcome the above, a resource to be used for E-PDCCH transmission may be set through a distributed resource allocation scheme and frequency selective scheduling. Also, as a scheme of obtaining diversity (frequency diversity) to transfer an E-PDCCH to a high-speed mobile UE, a distributed resource allocation scheme and distributed resource mapping scheme may be applied.

A case in which resources that may be used for E-PDCCH transmission is set to be apart from one another is referred to as the distributed resource allocation. Although the distributed resource allocation may be variously used according to the technology, the distributed resource allocation has the above described meaning according to an embodiment of the present invention.

In the case of the E-PDCCH, a scheme of supporting multiplexing among a plurality of E-PDCCHs in the identical frequency may be considered for maximizing the control channel capacity. For a low-speed UE for which CSI (Channel State Information) is available, a scheme of supporting spatial multiplexing among user equipments (beamforming (precoding)-based multiplexing) may be used. For UEs for which CSI information is unavailable, a time domain code spreading scheme that supports code division multiplexing may be used.

The present specification will describe a scheme that executes resource mapping in the state in which distributed resource allocation is used, so as to support E-PDCCH transmission appropriately for a channel state of each user equipment, and efficiently sets a search space from which a UE determines an E-PDCCH. In particular, the present specification provides a scheme that transmits an E-PDCCH to support distributed/localized E-PDCCH mapping during resource mapping, and sets a search space for an E-PDCCH. Also, the present specification provides various multiplexing schemes (spatial multiplexing/code division multiplexing) based on whether CSI information is available, and simultaneously, provides a search space allocation scheme that provides a low blind detection complexity so as to execute E-PDCCH detection.

The scheme provided in the present invention will be briefly described as follows.

An E-PDCCH search space is divided into two regions so that a blind detection complexity may be decreased.

An E-PDCCH region in which each UE executes reception is limited based on whether a multiplexing scheme (SDM, CDM) is used in the region, so that a blind detection complexity may be decreased, or an E-PDCCH region in which each UE executes reception is limited through a high layer signaling, so that a blind detection complexity may be decreased.

By limiting an E-PDCCH aggregation level, a blind detection complexity may be decreased. For a few aggregation levels, all the two multiplexing schemes may be applied.

Hereinafter, an operational mechanism of the schemes required for implementing the method of the present specification will be provided, and embodiments of the present invention integrating the same will be described.

An example of the method of transmitting control information through a resource shared with for a PDSCH (using a wireless resource that may be used for PDSCH transmission or other data channel transmission) may include an E-PDCCH and an R-PDCCH (Relay-PDCCH). Those have a feature in which they are included in a PDSCH for transmission, and the E-PDCCH or the R-PDCCH executes resource allocation and transmission using a CCE (Control Channel Element) or an RB (Resource Block) as a basic unit.

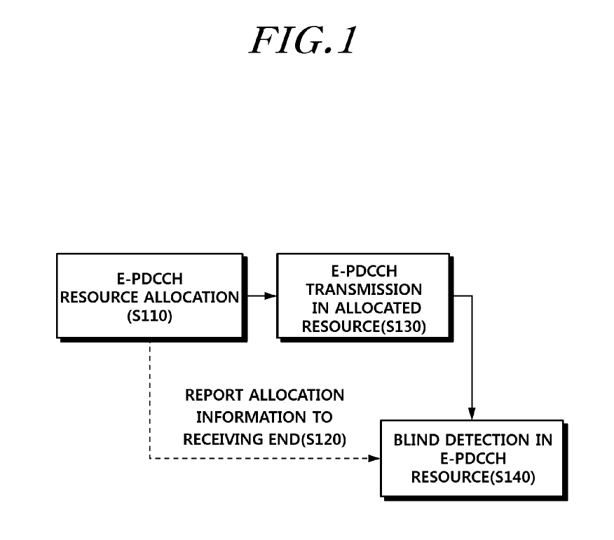

FIG. 1 is a diagram illustrating a process of resource allocation and transmission of an E-PDCCH, and blind detection of a receiving end according to an embodiment of the present invention.

A base station allocates a resource region in which an E-PDCCH is to be transmitted (Resource Allocation) in operation S110. The base station reports the allocated region to a receiving end, for example, a UE, in operation S120. When the base station transmits an E-PDCCH in the allocated resource in operation S130, the receiving end executes blind detection in the allocated resource in operation S140, so as to determine the E-PDCCH.

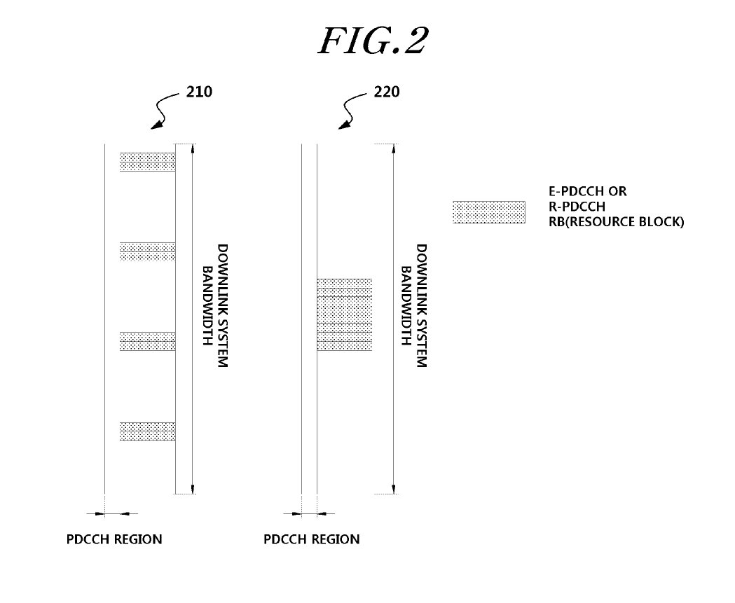

FIG. 2 is a diagram illustrating distributed resource allocation and localized resource allocation, which are resource allocation schemes according to an embodiment of the present invention. FIG. 2 shows resource allocation of the type in which control information is included in a region of a PDSCH for transmission, such as an R-PDCCH or an E-PDCCH. Also, it shows resource allocation using an RB as a basic unit.

An E-PDCCH or an R-PDCCH RB (resource block) specified in FIG. 2 is a resource block (RB) that may be used for transmission of an E-PDCCH or an R-PDCCH, and a few or all of the RBs may be used for transmission of an E-PDCCH or an R-PDCCH.

The diagram 210 indicates a distributed resource allocation scheme, and resources in varied frequency bandwidths may be selected. The diagram 220 indicates a localized resource allocation scheme, and resources in a predetermined frequency bandwidth may be selected.

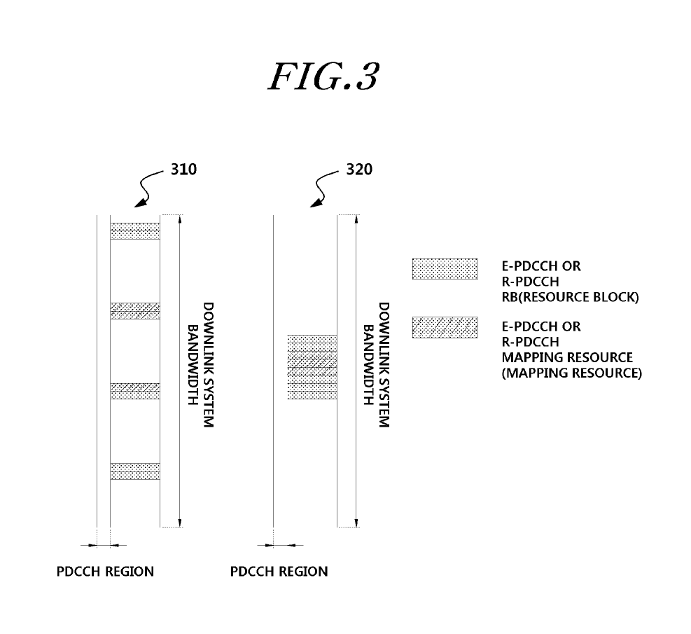

FIG. 3 is a diagram illustrating an E-PDCCH resource mapping scheme, according to an embodiment of the present invention. Resource mapping indicates actually mapping an E-PDCCH in a resource-allocated region. The diagram 310 of FIG. 3 shows resource mapping in the distributed resource allocation scheme of the diagram 210 of FIG. 2. The diagram 320 shows resource mapping in the localized resource allocation scheme of the diagram 220 of FIG. 2.

Both the diagrams 310 and 320 show examples in which an E-PDCCH or an R-PDCCH is mapped to 3rd, 4th, and 5th RBs in the allocated resource region.

As described in the above, to provide an E-PDCCH, processes such as resource allocation, blind detection, resource mapping, or the like are required. A multiplexing scheme is required to transmit an E-PDCCH for a plurality of UEs in a single resource. All of these functions may be applied to embody the present invention.

First, E-PDCCH resource allocation based on the distributed resource allocation scheme of FIGS. 2 and 3 will be described. An E-PDCCH or an R-PDCCH of FIG. 3 uses an RB as a basic unit.

The R-PDCCH and the E-PDCCH are similar in that control information is transmitted in a PDSCH region. However, the R-PDCCH is transmitted in a channel between an eNB and a relay, and the E-PDCCH is transmitted in a channel between an eNB and a UE. The channel between the eNB and the relay, through which the R-PDCCH is transmitted, has an LoS (line of sight) with an significantly high probability, has a low frequency selectivity, and has a low propagation loss. That is, a channel having a good propagation characteristic may be formed. Conversely, the channel between the eNB and the UE, through which the E-PDCCH is transmitted, has various changes in a propagation loss due to various environmental factors, or has a high frequency selectivity.

Therefore, the distributed resource allocation scheme that may obtain a sufficient scheduling gain from a frequency selective channel may be more efficient for the E-PDCCH resource allocation. However, in the case of the distributed-resource allocation scheme, frequency bands are distributed and an E-PDCCH may be mapped to a few or all of the frequency bands and thus, blind detection for detecting an E-PDCCH may be executed.

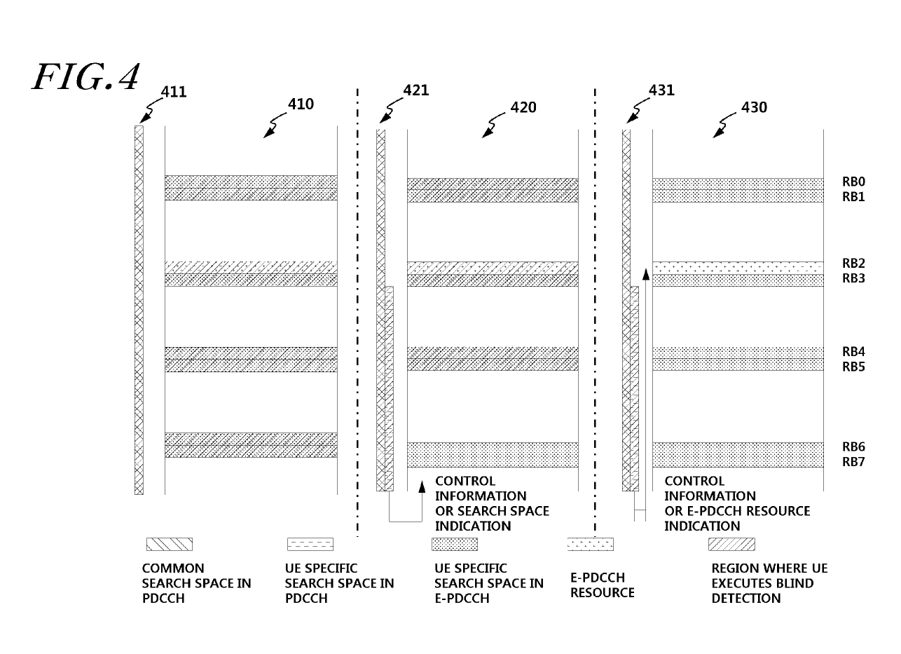

FIG. 4 is a diagram illustrating various embodiments of executing blind detection when an E-PDCCH uses a distributed resource allocation scheme, according to an embodiment of the present invention. The diagrams 410, 420, and 430 show respective embodiments.

Here, the diagrams 411, 421, and 431 indicate a common search space in PDCCH, and the diagrams 410, 420, and 430 show current RB0, RB1, . . . , and RB7 which indicate an E-PDCCH resource allocated region (E-PDCCH Resource Allocation).

The diagram 410 shows a process in which a UE detects an E-PDCCH mapped resource (mapping resource) through blind detection without a separate signaling (dynamic signaling) associated with E-PDCCH mapping. That is, although an E-PDCCH is mapped to the RB2 of the diagram 410, the UE executes blind detection with respect to RB0, RB1, RB2, RB3, RB4, RB5, RB6, and RB7 which are the resource-allocated region.

The diagrams 420 and 430 transfer, to the UE, information associated with E-PDCCH mapping using a short DCI format. That is, the diagram 420 indicates information associated with a space in which blind detection is to be executed (control information or search space indication), and the diagram 430 accurately indicates a resource to which an E-PDCCH is actually mapped (Control information or E-PDCCH resource indication). The diagram 420 or the diagram 430 may receive an E-PDCCH by reducing the number of E-PDCCH blind detections or without blind detection.

The distributed resource allocation scheme secures a large scheduling gain in a frequency selective channel. However, when a change in a channel is fast due to a high mobility of a UE, a scheduling speed is relatively slower than the change in the channel and a scheduling gain may not be obtained. In this case, the performance may reach the limit. In this instance, a scheme of increasing an aggregation level of an E-PDCCH and obtaining a frequency diversity gain may be attempted.

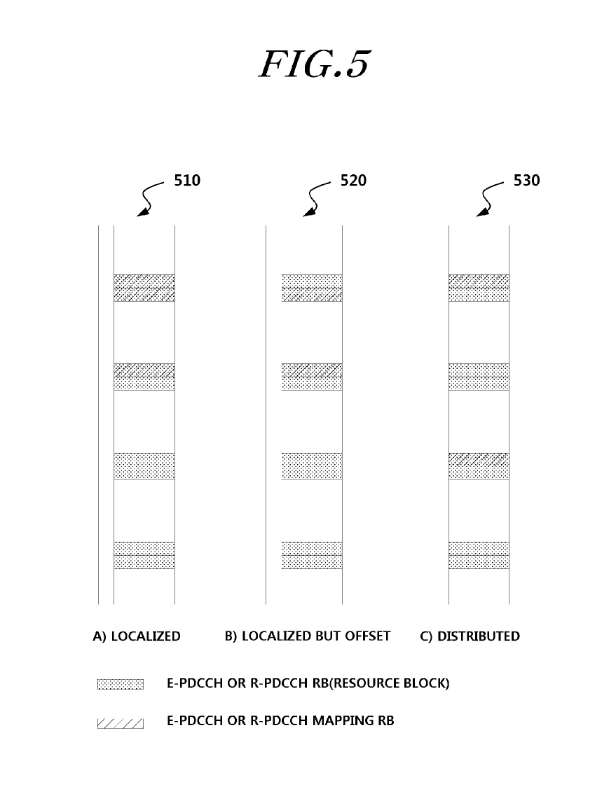

FIG. 5 is a diagram illustrating three schemes that increase an aggregation level and obtains a frequency diversity gain according to an embodiment of the present invention. When a scheme of determining a location where E-PDCCH mapping starts based on an aggregation level is used, to reduce a blind detection complexity or the number of blind detections, a localized mapping scheme of the diagram 510 may be used. In this example, a minimum aggregation level that may obtain a frequency diversity may be determined based on an E-PDCCH resource allocation scheme. In the examples of FIGS. 2 through 4, a frequency diversity gain may be obtained when an aggregation level is greater than or equal to 3. To obtain a frequency diversity gain using a smaller aggregation level, a localized but offset mapping scheme of the diagram 520 may be applied. Also, to obtain a frequency diversity gain using a further smaller aggregation level, a distributed mapping scheme of the diagram 530 may be applied.

However, when mapping schemes of the diagrams 520 and 530 are allowed, the number of resource mapping schemes that need to be considered when the UE executes E-PDCCH blind detection increases and thus, a blind detection complexity may increase. In the case of an E-PDCCH, detection delay may be a significantly important factor and thus, it may be needed to decrease the blind detection complexity so as to reduce E-PDCCH detection delay and PDSCH decoding delay, thereby increasing the efficiency of transmission.

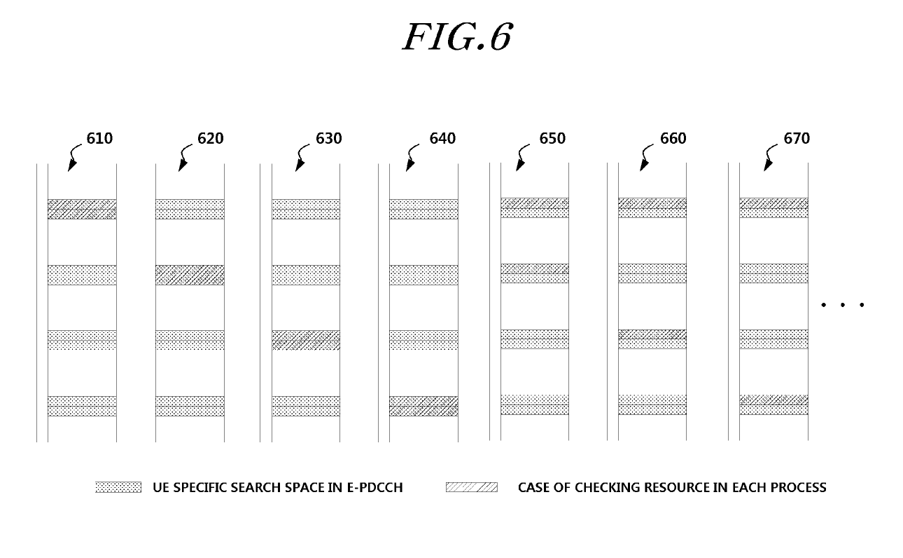

FIG. 6 illustrates a blind detection process executed by a UE according to an embodiment of the present invention. FIG. 6 shows a part of the blind detection process executed by the UE when a localized resource mapping scheme which is a general resource mapping scheme and a distributed resource mapping scheme are used together. This shows that the blind detection is executed after performing a lot of processes 610, 620, 630, 640, 650, 660, and 670.

Therefore, a method that supports E-PDCCH multiplexing among E-PDCCHs will be described, to reduce an E-PDCCH blind detection complexity, and to add a scheduling gain and a frequency diversity gain to an E-PDCCH.

First, a method of implementing the E-PDCCH multiplexing will be described as follows.

The E-PDCCH multiplexing may be classified into three schemes as follows: i) an SDM (spatial division multiplexing) scheme using beam-forming, ii) a TCDM (Time domain code division multiplexing) scheme based on a time domain, and iii) an FDM (Frequency Division multiplexing) corresponding to a frequency division scheme. The E-PDCCH multiplexing may enable simultaneous transmission of control information to a plurality of UEs. Basically, FDM corresponding to a frequency division scheme in which UEs use different E-PDCCH resources from each other may be used. When two or more E-PDCCHs need to share the identical resource, SDM corresponding to a spatial division scheme that is based on beam forming (or precoding) may be applied.

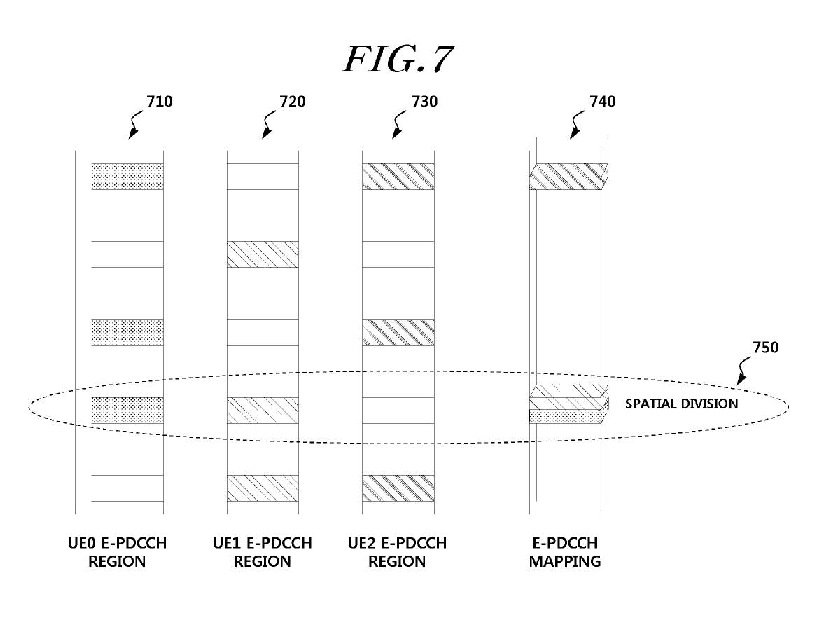

FIG. 7 is a diagram illustrating SDM of the E-PDCCH multiplexing scheme according to an embodiment of the present invention.

The diagram 710 is an E-PDCCH region of a UE0, the diagram 720 is an E-PDCCH region of a UE1, and the diagram 730 is an E-PDCCH region of a UE2. The diagram 740 is an example of mapping the E-PDCCH regions of the UE0, the UE1, and the UE2, and the diagram 750 shows that the E-PDCCH regions of the UE0 and the UE1 are multiplexed based on the SDM scheme. This may be applied when the UE0 and the UE1 are spatially divided by beam-forming.

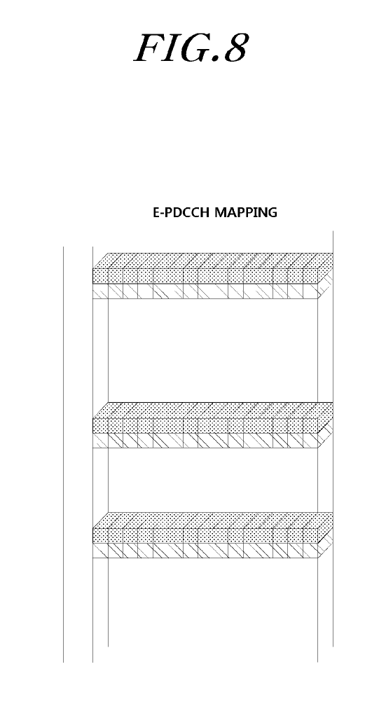

When an eNB learns accurate channel information of each bandwidth in which an E-PDCCH is transmitted, spatial division of FIG. 7 may be possible but multiplexing through spatial division based on beam-forming may be difficult due to a high mobility UE or the like. In this instance, FDM may be applied, or a time domain code division multiplexing (TCDM) of FIG. 8 may be performed.

FIG. 8 is a diagram illustrating TCDM of the E-PDCCH multiplexing scheme according to an embodiment of the present invention. This shows that an E-PDCCH is mapped to each E-PDCCH resource allocated region based on code division. FIG. 8 shows broadband or wideband E-PDCCH transmission and TDCM for obtaining a frequency diversity gain.

Hereinafter, in order to reduce the blind detection complexity associated with an E-PDCCH, a scheme of reducing the number of blind detections by allowing a base station and a user equipment to map an E-PDCCH within only a predetermined region, or allowing a user equipment to predict information associated with E-PDCCH mapping based on an aggregation level of a predetermined E-PDCCH, will be described.

As a first embodiment of the present invention, a scheme that divides an E-PDCCH region for applying a different multiplexing scheme to each region, and enables a user equipment to execute blind detection based on a corresponding scheme, will be described. In other words, the first embodiment indicates dividing the E-PDCCH region into a common E-PDCCH region and a UE specific E-PDCCH region. According to a detailed embodiment provided to this end, the common E-PDCCH region may be configured as an E-PDCCH region of a code division scheme that has been described in FIG. 8, and the UE specific E-PDCCH region may be configured as a spatial division E-PDCCH region.

An E-PDCCH allocated to each of the two E-PDCCH division regions may be mapped in a different scheme, and the mapping scheme may be interoperated with the E-PDCH multiplexing scheme. That is, the multiplexing scheme may be determined based on a region of an E-PDCCH region and a mapping scheme.

In the case of the common E-PDCCH region, all user equipments may recognize a location of the corresponding region, and TCDM (time domain code division) may be executed. In the case of the UE specific E-PDCCH region, each terminal is informed of a location separately, and SDM corresponding to spatial division may be used. The example provided above is one of the examples associated with search space allocation, and the TCDM region does not need to be a common region or the SDM region does not need to be a UE specific region.

When a base station, for example, an eNB, collects information associated with a user equipment (for example, a UE), a state of a network, or the like and determines that a frequency diversity gain is required, the eNB executes E-PDCCH mapping so as to obtain a frequency diversity gain in the TCDM region or the common region, and executes time domain code spreading in the above process. The code is different for each UE, and a code of each UE is orthogonal or semi-orthogonal and thus, may be distinguished. Based on the orthogonality, a user equipment may distinguish an E-PDCCH.

Conversely, when a scheduling gain is required, an eNB transmits an E-PDCCH in the SDM region or the UE specific region.

According to a detailed example of the first embodiment, an E-PDCCH may have various aggregation levels (aggregation level, AL) in the UE specific region and the common region, and an E-PDCCH aggregation level that each UE may have may be limited so as to reduce the complexity (blind detection complexity) of blind detection executed by the UE. Also, an E-PDCCH region in each UE executes reception may be limited to a common or UE specific region, through a high layer signaling. For example, the UE0 may be limited to receive only an E-PDCCH of AL 4 in only the common region. The limitation may be a UE specific or cell specific limitation, or may limit the entire system. As another example, an eNB may inform each UE of E-PDCCH resource limitation information for each resource.

The signaling scheme will be described in more detail as follows. When each UE desires to receive an E-PDCCH without a separate high layer signaling transferred through a PDSCH, E-PDCCH resource allocation needs to be executed in a form of system information or a system common parameter. After the resource allocation, limitation information associated with a resource from which each UE may predict E-PDCCH reception among the resources or limitation information associated with a transmission scheme may be transferred to each UE through control information through a high layer signaling by taking into consideration situation of each UE. The high layer signaling may be an RRC (Radio Resource Control) signaling.

As another detail embodiment of the first embodiment, i) a user equipment may receive a PDCCH and receive information associated with E-PDCCH resource allocation through a PDSCH, and may enable E-PDCCH reception after the process. ii) An eNB transfers limitation information associated with an E-PDCCH resource and a transmission scheme to a UE in a form of a high layer signaling or control information, by taking into consideration the situation of each UE.

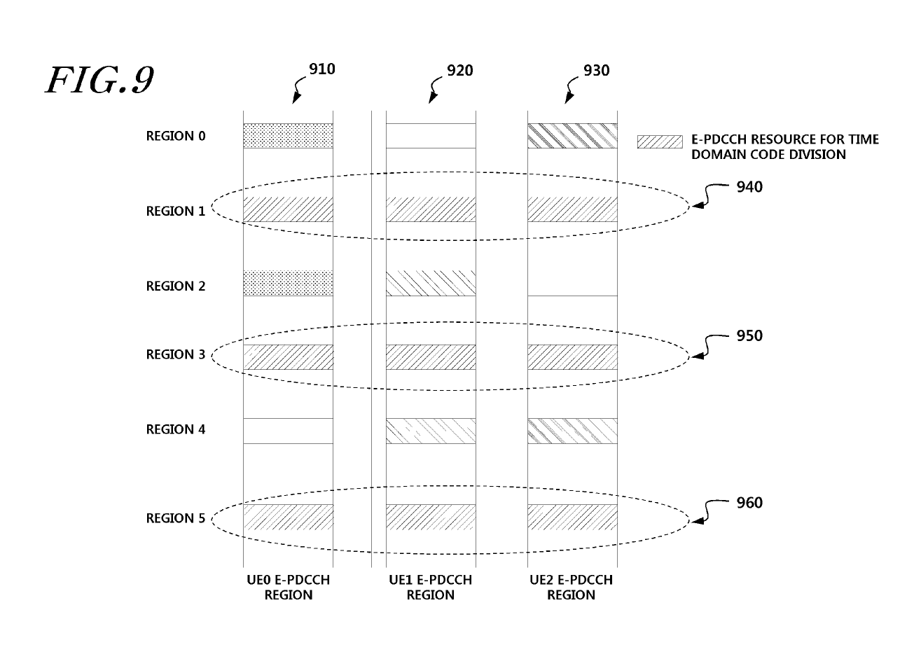

FIG. 9 is a diagram illustrating a region of an E-PDCCH resource according to the first embodiment of the present invention.

The diagrams 910, 920, and 930 of FIG. 9 show E-PDCCH regions of a UE0, a UE1, and a UE2, respectively. The UE0 corresponds to regions 0, 1, 2, 3, and 5, the UE1 corresponds to regions 1, 2, 3, 4, and 5, and the UE2 corresponds to regions 0, 1, 3, 4, and 5. A common region corresponds to regions 1, 3, and 5, and in which an E-PDCCH resource is set to execute TCDM (Time domain code division) multiplexing as shown in the diagrams 940, 950, and 960. This is for a frequency diversity gain. Information associated with a configuration of a common region or a UE specific region, or information associated with a region where an E-PDCCH is mapped from among the common region and the UE specific region may be provided to a UE through a high layer signaling or as system information, as described above. Therefore, based on the information, the UE may execute blind detection in only the common region or in only the UE specific region, thereby reducing a blind detection complexity.

According to a second embodiment of the present invention, a blind detection complexity of a user equipment may be reduced by modifying or changing an E-PDCCH mapping scheme based on an aggregation level.

When the first embodiment of the present invention is applied, an E-PDCCH region allocated to each UE may be divided into a frequency selective scheduling region (UE specific region) and a frequency diversity region (common region) and thus, an E-PDCCH region that provides a scheduling gain may be reduced. This may be a factor that reduces utilization of the E-PDCCH region.

According to the second embodiment, an E-PDCCH region is set for each UE, and an E-PDCCH transmission scheme is determined in each region, based on an E-PDCCH aggregation level. As described above, in the case in which an E-PDCCH region is set through distributed resource allocation, when an aggregation level becomes high, this may be construed to be a wideband E-PDCCH transmission as opposed to narrow band E-PDCCH transmission. Therefore, when an aggregation level is greater than a predetermined level (large aggregation level), a scheduling gain may be decreased. In other words, deterioration in performance due to a decrease in a scheduling gain does not occur when only the distributed mapping is used for the case in which the aggregation level is greater than a predetermined level.

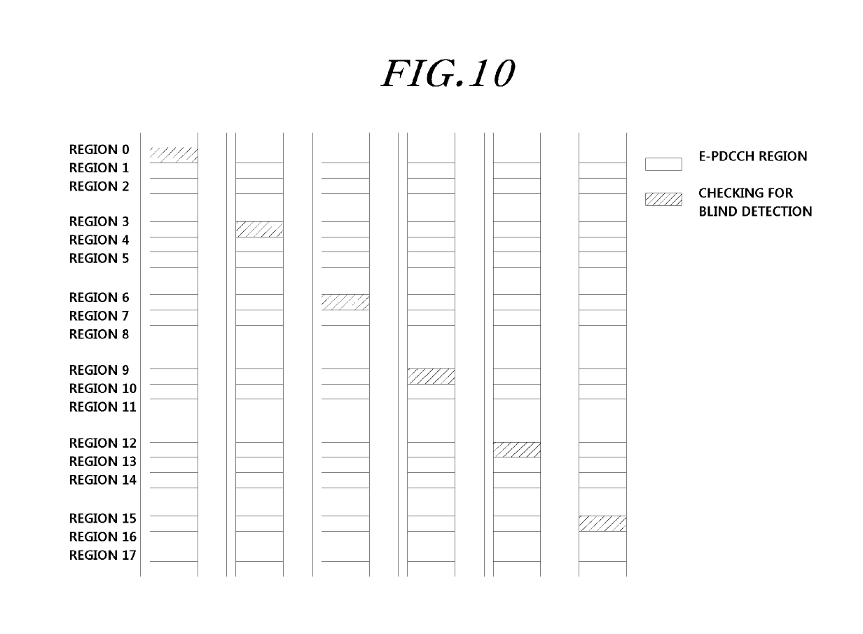

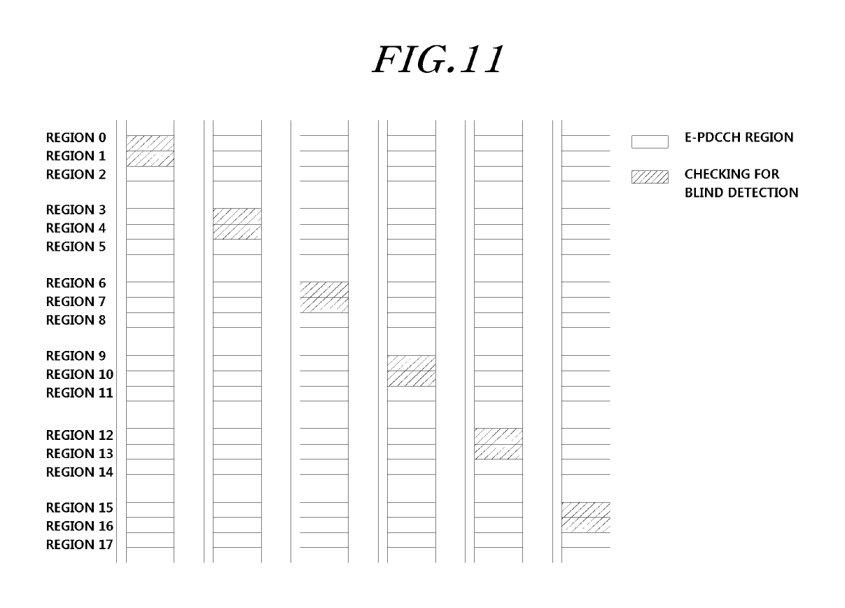

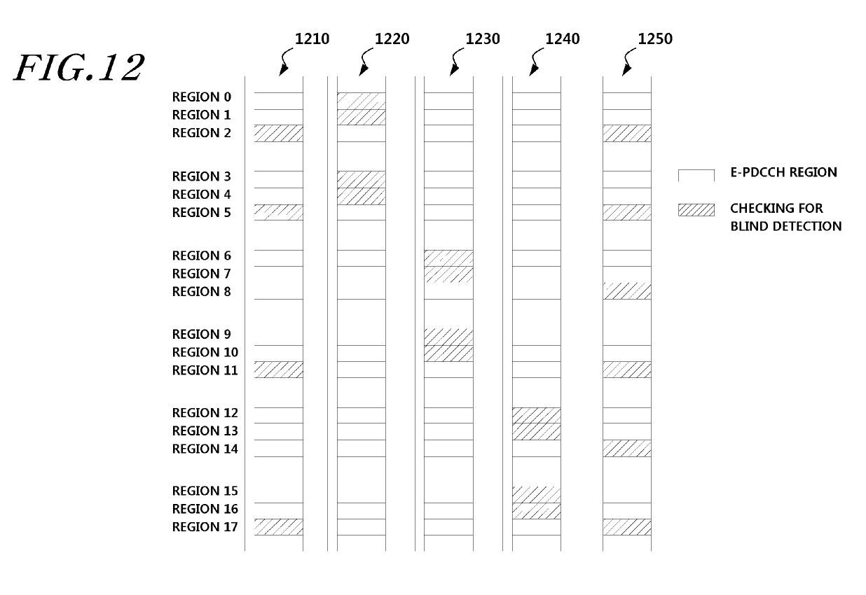

FIGS. 10, 11, and 12 are diagrams illustrating an example of changing E-PDCCH mapping based on an aggregation level according to the second embodiment of the present invention. FIGS. 10, 11, and 12 show cases that support aggregation levels are AL 1, 2, 4, and 6 in an E-PDCCH region. FIG. 10 shows AL 1, FIG. 11 shows AL 2, and FIG. 12 shows AL 4 and AL 6. In the case of AL 4 and AL 6, it may be construed to be wideband E-PDCCH transmission. Therefore, for a large AL, only distributed mapping is supported. Also, for multiplexing among control information that use distributed/localized mapping, time domain code spreading may be executed with respect to control information that uses localized mapping. For example, code spreading may be executed with respect to all aggregation levels, or code spreading may be supported with respect to an aggregation level 2 or higher. This may be summarized as follows.

The second embodiment-1: all E-PDCCHs execute time domain code spreading.

That is, localized mapping is executed with respect to a few aggregation levels (e.g., 1 and 2) and distributed mapping is executed with respect to a few aggregation levels (e.g., 4 and 6). Particularly, both localized/distributed mapping are supported with respect to a few aggregation levels (e.g., 4). In the second embodiment-1, E-PDCCH multiplexing may be supported by FDM (Frequency Division Multiplexing) and TCDM (time domain Code Division Multiplexing).

The second embodiment-2: time domain code spreading is executed with respect to a few aggregation levels or a few mapping schemes of a few aggregation levels.

That is, localized mapping is executed with respect to a few aggregation levels (e.g., 1 and 2) and distributed mapping is executed with respect to a few aggregation levels (e.g., 4 and 6). Particularly, both localized/distributed mapping are supported with respect to a few aggregation levels (e.g., 4). In the second embodiment-2, E-PDCCH multiplexing is executed through FDM (Frequency Division Multiplexing), and TCDM (time domain Code Division Multiplexing) is additionally supported with respect to an aggregation level 2 or higher.

Also, in the case of the distributed mapping, an offset between resources to be mapped is set in advance and thus, the complexity of blind detection may be reduced.

FIG. 10 and FIG. 11 show E-PDCCH mapping that does not use code division multiplexing when aggregation levels are 1 and 2.

In FIG. 10, when an aggregation level is 1, an E-PDCCH is set to be mapped in only the regions 0, 3, 6, 9, 12, and 15 so that an offset of each region is 3. Accordingly, E-PDCCH blind detection is executed in only the regions. In FIG. 11, when an aggregation level is 2, an E-PDCCH is set to be mapped in only the regions 0, 1, 3, 4, 6, 7, 9, 10, 12, 13, 15, 16 so that an offset of each region is 2.

FIG. 12 shows an example of E-PDCCH mapping when an aggregation level is 4 through the diagrams 1210, 1220, 1230, and 1240, and shows an example of E-PDCCH mapping when an aggregation level is 6 through the diagram 1250. The diagram 1210 of the aggregation level 4 and the diagram 1250 of the aggregation level 6 show examples of distributed mapping. When distributed mapping is executed, an E-PDCCH is set to be mapped in only the regions 2, 5, 11, and 17 in the diagram 1210 of FIG. 12 and an E-PDCCH is set to be mapped in only the regions 2, 5, 8, 11, 14, and 17 in the diagram 1250 of FIG. 12, to not overlap the regions used by the aggregation levels 1 and 2 of FIGS. 10 and 11. The diagrams 1220, 1230, and 1240 of the aggregation level 4 show examples of localized mapping, and mapping is executed based on the SDM scheme and thus, the diagrams 1220, 1230, and 1240 may be implemented to overlap the regions of FIGS. 10 and 11. Therefore, a user equipment may execute blind detection differently based on an aggregation level.

To sum up the descriptions with reference to FIGS. 10 through 12, an example of E-PDCCH mapping that does not use code division multiplexing with respect to distributed mapping in the aggregation levels 1 and 2 and in the aggregation level 4, has been described, in which time domain code spreading may be set to be not necessary for an E-PDCCH that is mapped based on localized mapping, by separating a resource used for distributed mapping and a resource used for localized mapping.

In FIGS. 10 through 12, the number of blind detections is a total of 6 when the aggregation level is 1, the number of blind detections is a total of 6 when the aggregation level is 2, the number of blind detections is a total of 4 when the aggregation level is 4, and the number of blind detections is a total of 1 when the aggregation level is 6 and thus, the total number of blind detections is 17.

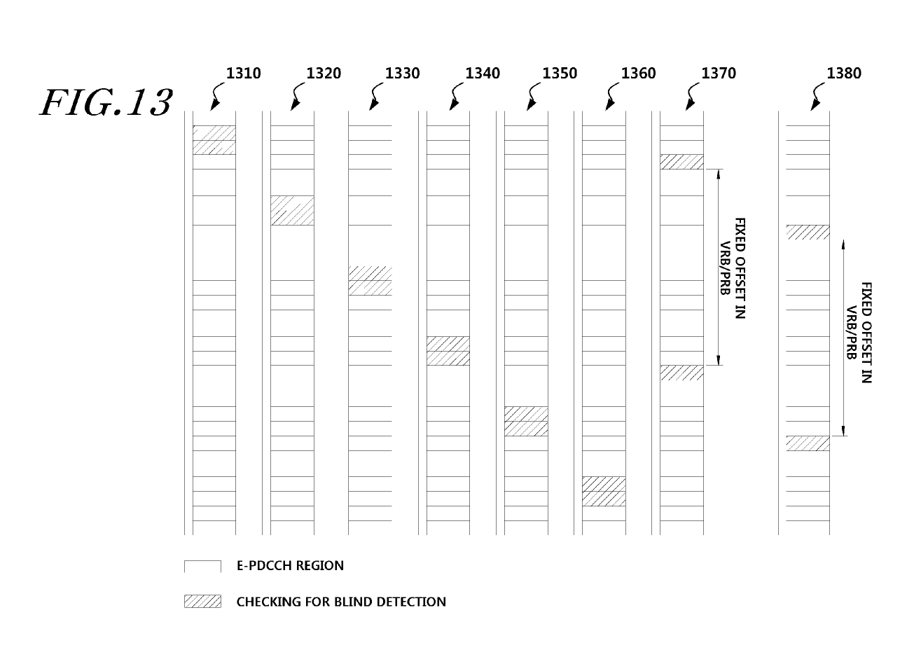

FIG. 13 is a diagram illustrating an example of executing blind detection when the second embodiment of the present invention is applied. There is provided an example of mapping in the aggregation level 2 when it is set that distributed mapping is supported for the aggregation level 2 and distributed mapping is not supported for the aggregation level 4. In FIG. 13, when the aggregation level 2 supports localized mapping as shown in the diagrams 1310, 1320, 1330, 1340, 1350, and 1360 and supports distributed mapping as shown in the diagrams 1370 and 1380, and an offset between resources mapped based on distributed mapping is set in advance as shown in the diagrams 1370 and 1380, the number of blind detections may be reduced.

Table 1 shows the number of blind detections of a PDCCH, and it is determined that the number of blind detections of an E-PDCCH is similar to or less than the number of blind detections of the PDCCH, though the comparison with the number of blind detections of FIGS. 10 through 12.

TABLE 1

| Search space | | | Number of PDCCH |
|---|---|---|---|
| Type | Aggregation level | Size [in CCEs] | candidates |
| UE specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

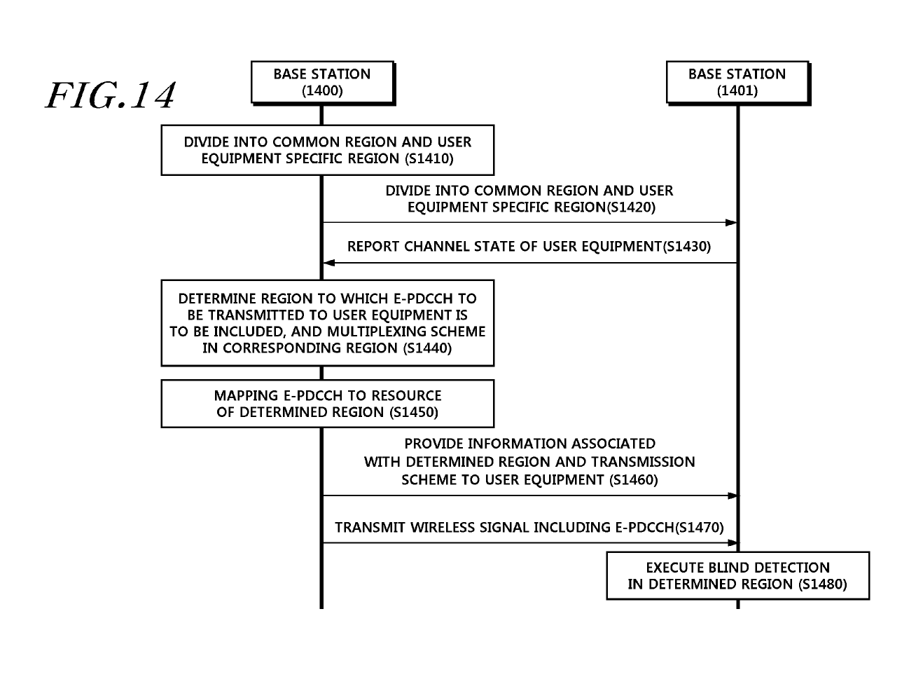

FIG. 14 is a diagram illustrating a process executed between a base station and a user equipment, to implement the first embodiment of the present invention.

A base station 1400 divides an E-PDCCH region into a common region and a UE specific region in operation S1410. The E-PDCCH region is in a state in which resources are allocated to two or more regions based on distributed resource allocation. The base station provides a user equipment 1401 of information associated with the division regions in operation S1420. The division of the region may be maintained to be semi-persistent and thus, the information associated with the division regions may be provided to the user equipment through a high layer signaling, a system information providing scheme, or the like.

Subsequently, a channel state of the user equipment 1401 is reported in operation S1430. In which of the common region/UE specific region an E-PDCCH is to be included or how an E-PDCCH is to be multiplexed may be determined based on the channel state of the user equipment, and the channel state may be selectively reported.

The base station 1400 may determine a region where the E-PDCCH to be transmitted to the user equipment is included, and a multiplexing scheme in the corresponding region, based on the channel state information reported by the user equipment 1401, in operation S1440. That is, when the corresponding user equipment requires a frequency diversity gain, the E-PDCCH is included in the common region and time domain code spreading may be used as the multiplexing scheme. Conversely, when the corresponding user equipment requires a scheduling gain, the E-PDCCH is included in the UE specific region. The E-PDCCH is mapped to a resource of the determined region in operation S1450. The information associated with the determined region and the transmission scheme may be provided to the user equipment in operation S1460, which may be provided through a high layer signaling, transferred through a system information scheme, or provided by including information associated with the corresponding region in control information as shown in the diagrams 420 and 430 of FIG. 4. When the information is included in the control information, the information may be transmitted together with the E-PDCCH. The base station 1400 transmits a wireless signal including the mapped E-PDCCH in operation S1470, and the user equipment 1401 may execute blind detection in the determined region in operation S1480.

As described above, in FIG. 14, a region in which an E-PDCCH is transmitted is divided into a common region and a user equipment specific region. In a process implementing the above, an aggregation level of a received E-PDCCH is limited for each user equipment and thus, a complexity of blind detection may be further reduced.

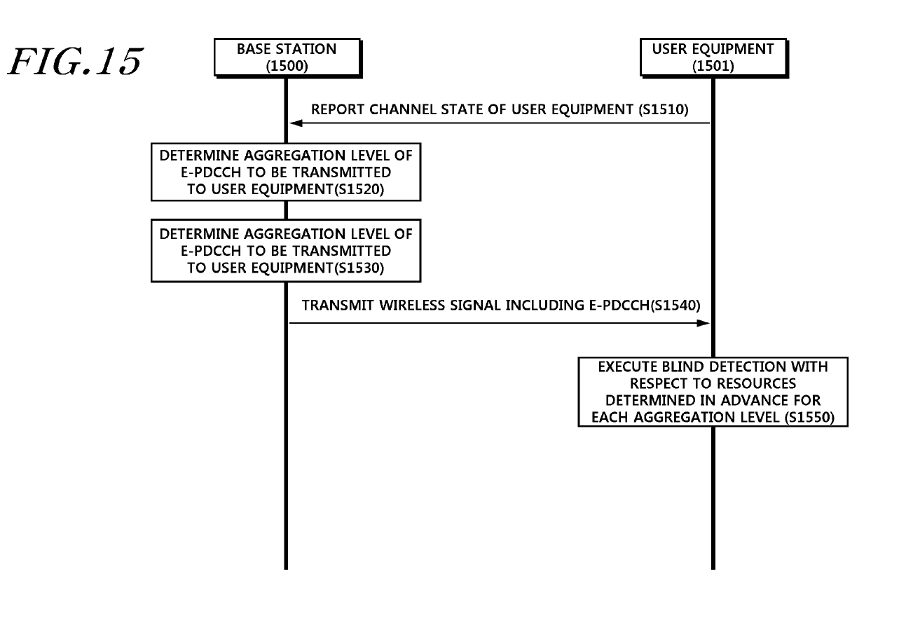

FIG. 15 is a diagram illustrating a process executed between a base station and a user equipment, to implement the second embodiment of the present invention.

A base station 1500 receives a report on a channel state of a user equipment in operation S1510. The base station determines an aggregation level of an E-PDCCH to be transmitted to the user equipment in operation S1520. The base station maps the E-PDCCH to a limited resource based on the aggregation level in operation S1530. As described in the descriptions of the second embodiment, a region to which an E-PDCCH is to be mapped may be limited based on an aggregation level, and a multiplexing scheme of the E-PDCCH may be limited based on the aggregation level. Based on the limited mapping scheme, the base station 1500 transmits, to the user equipment 1501, a wireless signal including the mapped E-PDCCH in operation S1540, and the user equipment executes blind detection with respect to resources determined in advance based on an aggregation level in operation S1550.

In the first and second embodiments, and FIGS. 14 and 15, a case in which a base station dividing resource allocation with respect to an E-PDCCH region and executing mapping by changing a region based on a channel state of a user equipment, or a case of mapping an E-PDCCH by changing a mapping scheme based on an aggregation level of the E-PDCCH to be transmitted to the user equipment, are commonly designated “mapping rule.” Also, a case in which a user equipment recognizes information associated with the division regions in advance from a received wireless signal, and executes blind detection, or a case in which the user equipment executes blind detection with respect to resources determined in advance based on an aggregation level, these detection schemes are commonly designated “detection rule.” The detection rule of the user equipment is associated with the mapping rule of the base station, and the information associated with the mapping rule-detection rule may be provided by the base station to the user equipment at an initial stage and thus, may be semi-persistently used.

Meanwhile, when the base station determines a region and a scheme, an aggregation level for mapping an E-PDCCH with respect to a user equipment, the base station needs to determine channel information of the corresponding user equipment. That is, the base station executes E-PDCCH resource mapping based on the channel information. The user equipment measures a CRS or a CSI-RS, and informs the base station of the measurement. In this instance, the channel information may be wideband information or subband-based information. When a user equipment transfers channel information associated with each subband, the base station selects a resource appropriate for execution of E-PDCCH transmission based on the information, and when it is required to simultaneously transmit an E-PDCCH to two or more user equipments using an identical resource based on a channel state of each terminal, the base station executes E-PDCCH multiplexing. When multiplexing is impossible since the number of user equipments that require use of the identical resource or when a user equipment that requires a different multiplexing scheme prefers to use the identical resource, an E-PDCCH is transmitted to a few user equipments using a resource having a low priority, so as to overcome collision between E-PDCCHs.

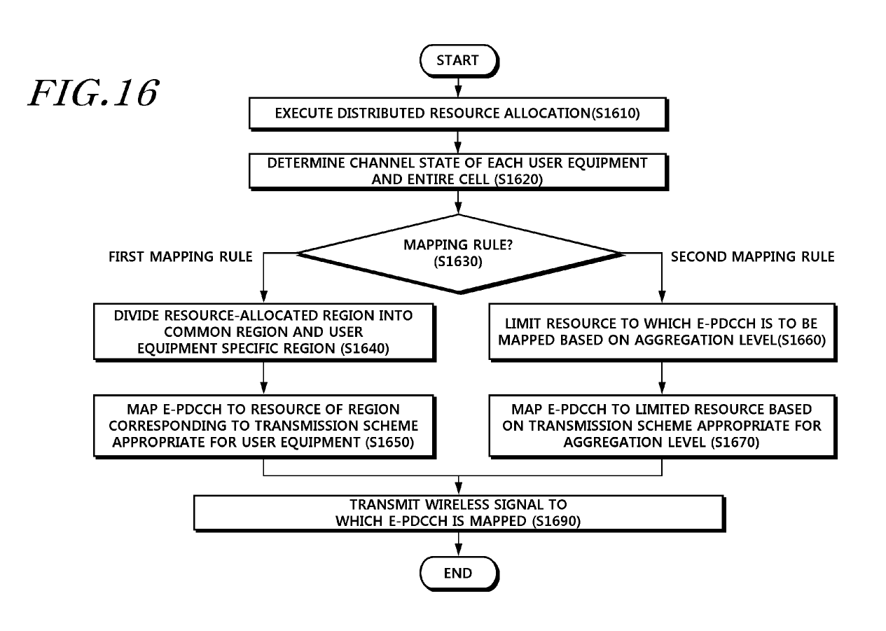

FIG. 16 is a diagram illustrating a process in which a base station executes mapping and transmitting of an E-PDCCH according to an embodiment of the present invention.

First, a base station executes distributed resource allocation in operation S1610. The base station determines a channel state of each user and the entire cell in operation S1620. As a matter of course, the channel state of a user equipment and the entire cell may be frequently determined. The base station may execute mapping based on whether an E-PDCCH mapping rule is a first mapping rule based on the first embodiment of the present invention or a second mapping rule based on the second embodiment of the present invention, in operation S1630.

First, the first mapping rule indicates mapping an E-PDCCH to a resource of a region that is indicated in advance to the user equipment. That is, as described in the first embodiment, a resource-allocated region is divided into a common region and a user equipment specific region in operation S1640. The base station maps an E-PDCCH to a resource in a region corresponding to a transmission scheme appropriate for each user equipment in operation S1650, and transmits an E-PDCCH-mapped wireless signal in operation S1690.

The first mapping rule sets two or more regions to a common region and a user equipment specific (User Equipment Specific) region, and the base station may transmit, to the user equipment through a high layer signaling, information indicating that the E-PDCCH is mapped to a resource of one of the common region and the user equipment specific region. In the common region, an E-PDCCH may be multiplexed based on a time domain code division scheme. The common region is a region in which an E-PDCCH is transmitted to a plurality of user equipments and thus, code division multiplexing may be executed through a code that satisfies orthogonality.

Meanwhile, the second mapping rule indicates mapping the E-PDCCH based on an aggregation level of the E-PDCCH. That is, as described in the second embodiment, the base station limits, based on an aggregation level, a resource to which an E-PDCCH is to be mapped in operation S1660, and maps the E-PDCCH in the limited resource based on a transmission scheme appropriate for the aggregation level in operation S1670. The base station transmits an E-PDCCH-mapped wireless signal in operation S1690.

The second mapping rule uses localized mapping when the aggregation level is less than k, and uses distributed mapping when the aggregation level is greater than or equal to k. In particular, when the aggregation level is k, both localized mapping and distributed mapping may be used. In the second embodiment, k may be 4.

When the second mapping rule is used, the E-PDCCH is multiplexed based on frequency division. For a few or all of the aggregation levels, multiplexing may be executed based on time domain code division scheme. As an example of the few aggregation levels, a time domain code division scheme may be applied to an aggregation level 2 or higher.

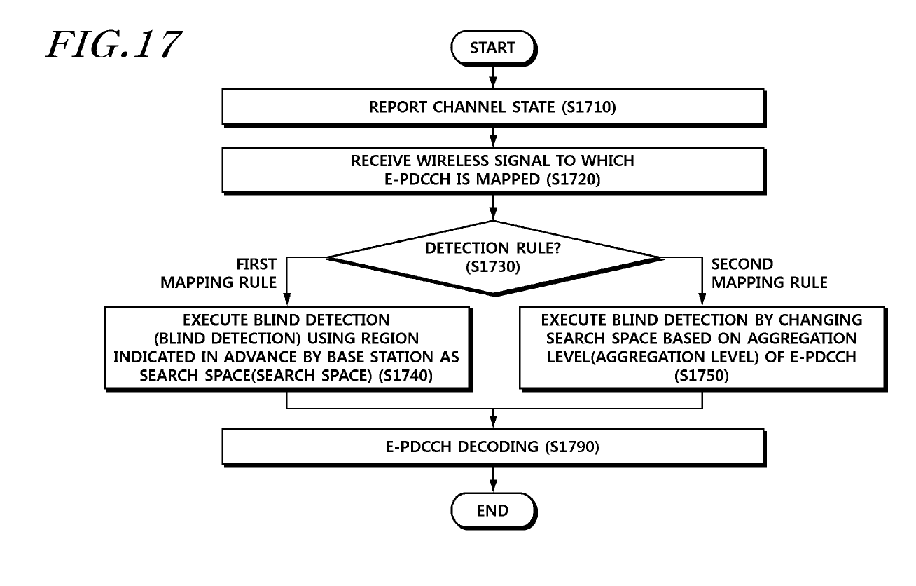

FIG. 17 is a diagram illustrating a process in which a user equipment receives a wireless signal to which an E-PDCCH is mapped, and executes blind detection of the same, according to an embodiment of the present invention.

A user equipment reports a channel state in operation S1710. The user equipment receives an E-PDCCH-mapped wireless signal in operation S1720. The user equipment may execute blind detection based on whether an E-PDCCH detection rule is a first detection rule based on the first embodiment of the present invention or a second detection rule based on the second embodiment of the present invention, in operation S1730.

First, when the first detection rule is used, the user equipment executes blind detection using a region that the base station indicates in advance, as a search space in operation S1740. An E-PDCCH is mapped to a resource in the region that the base station indicates to the user equipment and thus, blind detection is executed using the corresponding indicated region as a search space. When the blind detection is completed, the user equipment decodes the E-PDCCH in operation S1790.

In the first detection rule, the region indicated in advance corresponds to one of a common region and a user equipment specific region, and the user equipment receives, from the base station, information indicating that the E-PDCCH is mapped to a resource of one of the common region and the user equipment specific region. Accordingly, the user equipment may execute blind detection using one of the common region and the user equipment specific region as a search space. Also, as described above, when a resource is limited based on an aggregation level, the number of search spaces may be further reduced. In the common region, E-PDCCH may be received by being multiplexed based on a time domain code division scheme. This indicates that an E-PDCCH is received that is code division multiplexed through a code that satisfies orthogonality.

In the second detection rule, blind detection is executed by changing a search space based on an aggregation level of the E-PDCCH in operation S1750. According to the second embodiment, the E-PDCCH is mapped based on the aggregation level of the E-PDCCH and thus, a search space may be different for each aggregation level or a search space may be limited in advance based on an aggregation level. When the blind detection is completed, the user equipment decodes the E-PDCCH in operation S1790.

The second detection rule executes blind detection using, as a search space, a resource mapped based on localized mapping when the aggregation level is less than k, and executes blind detection using, as a search space, a resource mapped based on distributed mapping when the aggregation level is greater than or equal to k. In particular, when the aggregation level is k, the second detection rule executes blind detection using, as a search space, both the resource mapped based on the localized mapping and the resource mapped based on the distributed mapping. In the second embodiment, the case in which k is 4 has been described.

When the second detection rule is used, the E-PDCCH is multiplexed based on frequency division. For a few or all of the aggregation levels, multiplexing may be executed based on a time domain code division scheme.

As an example of the few aggregation levels, a time domain code division scheme may be applied to an aggregation level 2 or higher.

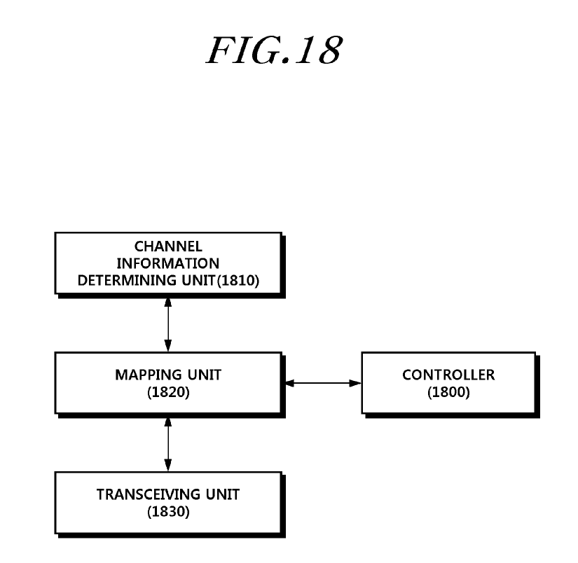

FIG. 18 is a diagram illustrating a configuration of a base station or an apparatus that is coupled to the base station, for mapping an E-PDCCH to a resource and transmitting a wireless signal, according to an embodiment of the present invention.

A controller 1800, a mapping unit 1820, a transceiving unit 1830, and a channel information determining unit 1810 are included as component elements.

The controller 1800 executes distributed resource allocation with respect to two or more region in which an E-PDCCH (Extended PDCCH) is to be transmitted, and the mapping unit 1820 applies a mapping rule to a resource of one or more regions of the two or more regions so as to map an E-PDCCH to be transmitted to a user equipment. The mapping rule that is applied when the mapping unit 1820 executes resource mapping includes one or more mapping rule from among a first mapping rule that maps an E-PDCCH to a resource in a region indicated in advance to the user equipment and a second mapping rule that maps the E-PDCCH based on an aggregation level of the E-PDCCH. This may indicate selectively applying one of the first mapping rule and the second mapping rule, or using both the first mapping rule and the second mapping rule together.

The transceiving unit 1830 provides a function of transmitting a wireless signal including the E-PDCCH to a user equipment, and a function of receiving a wireless signal from the user equipment.

The channel information determining unit 1810 determines a state of a channel and a wireless network, provided or separately measured by a user equipment.

The first mapping rule sets two or more regions to a common region and a user equipment specific region, and the controller 1800 may control the transceiving unit 1830 so as to transmit, to the user equipment, information indicating that the E-PDCCH is mapped to a resource of one of the common region and the user equipment specific region. In the common region, an E-PDCCH is multiplexed based on a time domain code division scheme. The common region is a region in which an E-PDCCH is transmitted to a plurality of user equipments and thus, the mapping unit 1820 may execute code division multiplexing through a code that satisfies orthogonality.

Meanwhile, the second mapping rule indicates mapping the E-PDCCH based on an aggregation level of the E-PDCCH. That is, as described in the second embodiment, the mapping unit 1820 limits, based on an aggregation level, a resource to which an E-PDCCH is to be mapped, and maps the E-PDCCH in the limited resource, based on a transmission scheme appropriate for the aggregation level.

The mapping unit 1820 applies the second mapping rule, and uses localized mapping when the aggregation level is less than k, and uses distributed mapping when the aggregation level is greater than or equal to k. In particular, when the aggregation level is k, both localized mapping and distributed mapping may be used. In the second embodiment, k may be 4.

When the mapping unit 1820 uses the second mapping rule, the E-PDCCH is multiplexed based on frequency division. For a few or all of the aggregation levels, multiplexing may be executed based on a time domain code division scheme. As an example of the few aggregation levels, a time domain code division scheme may be applied to an aggregation level 2 or higher.

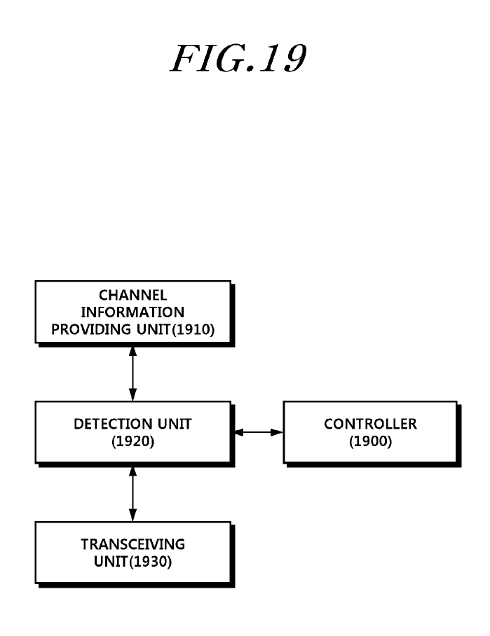

FIG. 19 is a diagram illustrating a configuration of a user equipment or an apparatus that is coupled to the user equipment, for receiving a wireless signal to which an E-PDCCH is mapped.

A controller 1900, a detection unit 1920, a transceiving unit 1930, and a channel information providing unit 1910 are included as component elements.

The transceiving unit 1930 receives a wireless signal including an E-PDCCH (Extended PDCCH) from a base station. The detection unit 1920 executes blind detection of the received wireless signal in two or more regions, based on a detection rule. The two or more regions correspond to a region to which the base station executes distributed resource allocation to transmit an E-PDCCH, and the detection unit 1920 may execute blind detection in the one or more regions of the two or more regions, based on a detection rule. As described above, the channel information providing unit 1910 generates information associated with channel state determined by a user equipment, and provides the information to the base station. The information may be provided to the base station by the controller 1900 through a wireless signal transmission process of the transceiving unit 1930. The controller 1900 may control the transceiving unit 1930, the detection unit 1920, and the channel information providing unit 1910. Also, the controller 1900 may decode an E-PDCCH when the blind detection is completed.

The detection unit 1920 may execute blind detection using one or more detection rules from among a first detection rule that executes blind detection using, as a search space, a region that the base station indicates in advance, and a second detection rule that executes blind detection by changing a search space based on an aggregation level of the E-PDCCH. This may indicate selectively applying one of the first detection rule and the second detection rule, or using both the first detection rule and the second detection rule together.

In the first detection rule, the region indicated in advance corresponds to one of a common region and a user equipment specific region, and the controller 1900 controls the transceiving unit 1930 to receive, from the base station through a high layer signaling, information indicating that the E-PDCCH is mapped to a resource of one of the common region and the user equipment specific region. Accordingly, the detection unit 1920 may execute blind detection using one of the common region and the user equipment specific region as a search space. Also, as described above, when a resource is limited based on an aggregation level, the number of search spaces may be further reduced. In the common region, an E-PDCCH may be received by being multiplexed based on a time domain code division scheme. This indicates that an E-PDCCH is received that is code division multiplexed through a code that satisfies orthogonality.

When the second detection rule is applied, the detection unit 1920 executes blind detection by changing a search space based on an aggregation level of the E-PDCCH. This indicates that a search space is different for each aggregation level or limited in advance based on an aggregation level, since the E-PDCCH is mapped based on an aggregation level of the E-PDCCH according to the second embodiment.

When the second detection rule is applied, the detection unit 1920 executes blind detection using, as a search space, a resource mapped based on localized mapping when the aggregation level is less than k, and executes blind detection using, as a search space, a resource mapped based on distributed mapping when the aggregation level is greater than or equal to k. In particular, when the aggregation level is k, the detection unit 1920 applies the second detection rule, and executes blind detection using, as a search space, both the resource mapped based on the localized mapping and the resource mapped based on the distributed mapping. In the second embodiment, the case in which k is 4 has been described.

When the second detection rule is applied, the E-PDCCH is multiplexed based on frequency division. For a few or all of the aggregation levels, multiplexing may be executed based on a time domain code division scheme.

As an example of the few aggregation levels, a time domain code division scheme may be applied to an aggregation level 2 or higher.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. An Extended Physical Downlink Control Channel (E-PDCCH) mapping and transmitting method, the method comprising:
executing, by a base station, distributed resource allocation with respect to two or more regions in which an E-PDCCH is to be transmitted; and
mapping the E-PDCCH to be transmitted to a user equipment using a mapping rule applied to a resource of one or more regions of the two or more regions,
wherein the mapping rule includes one or more mapping rules among a first mapping rule that maps the E-PDCCH to a resource in a region that is indicated in advance to the user equipment through a high layer signaling, and a second mapping rule that maps the E-PDCCH based on an aggregation level of the E-PDCCH.

2. The method as claimed in claim 1, wherein the first mapping rule sets the two or more regions to a common region and a user equipment specific region; and
the method further comprises:
transmitting, by the base station to the user equipment through the high layer signaling, information indicating that the E-PDCCH is mapped to a resource of one of the common region and the user equipment specific region.

3. The method as claimed in claim 1, wherein the second mapping rule uses localized mapping when the aggregation level is less than k (k is a natural number greater than or equal to 2), and uses distributed mapping when the aggregation level is greater than or equal to k.

4. The method as claimed in claim 3, wherein, when the aggregation level is k, both the localized mapping and the distributed mapping are used.

5. An Extended Physical Downlink Control Channel (E-PDCCH) receiving method, the method comprising:
receiving, by a user equipment from a base station, a wireless signal including an E-PDCCH; and
executing blind detection of the received wireless signal in one or more regions of two or more regions to which distributed-resource is allocated, based on a detection rule,
wherein the detection rule includes one or more detection rules among a first detection rule that executes blind detection using, as a search space, a region that is indicated by the base station in advance through a high layer signaling, and a second detection rule that executes blind detection by changing a search space based on an aggregation level of an E-PDCCH.

6. The method as claimed in claim 5, wherein the region indicated in advance of the first detection rule is one of a common region and a user equipment specific region, and
the method further comprises:
receiving, by the user equipment from the base station through the high layer signaling, information indicating that the E-PDCCH is mapped to a resource of one of the common region and the user equipment specific region.

7. The method as claimed in claim 5, wherein the second detection rule executes blind detection using, as a search space, a resource mapped based on localized mapping when the aggregation level is less than k (k is a natural number greater than or equal to 2), and executes blind detection using, as a search space, a resource mapped based on distributed mapping when the aggregation level is greater than or equal to k.

8. The method as claimed in claim 7, wherein, when the aggregation level is k, the second detection rule executes blind detection using both the resource mapped based on localized mapping and the resource mapped based on distributed mapping, as a search space.

9. An Extended Physical Downlink Control Channel (E-PDCCH) mapping and transmitting apparatus, the apparatus comprising:
a controller to execute distributed resource allocation with respect to two or more regions in which an E-PDCCH is to be transmitted;
a mapping unit to map the E-PDCCH to be transmitted a user equipment using a mapping rule applied to a resource of one or more regions of the two or more regions; and
a transceiving unit to transmit a wireless signal including the E-PDCCH,
wherein the mapping rule includes one or more mapping rules among a first mapping rule that maps the E-PDCCH to a resource in a region indicated in advance to the user equipment through a high layer signaling and a second mapping rule that maps the E-PDCCH based on an aggregation level of the E-PDCCH.

10. The apparatus as claimed in claim 9, wherein the first mapping rule sets the two or more regions to a common region and a user equipment specific region; and
the controller controls the transceiving unit to transmit, to the user equipment through the high layer signaling, information indicating that the E-PDCCH is mapped to a resource of one of the common region and the user equipment specific region.

11. The apparatus as claimed in claim 9, wherein the second mapping rule uses localized mapping when the aggregation level is less than k (k is a natural number greater than or equal to 2), and uses distributed mapping when the aggregation level is greater than or equal to k.

12. The apparatus as claimed in claim 11, wherein, when the aggregation level is k, both the localized mapping and the distributed mapping are used.

13. An Extended Physical Downlink Control Channel (E-PDCCH) receiving apparatus, the apparatus comprising:
a transceiving unit to receive, from a base station, a wireless signal including an E-PDCCH;
a detection unit to execute, based on a detection rule, blind detection of the received wireless signal in one or more regions of two or more regions to which distributed resource is allocated; and
a controller that controls the transceiving unit and the detection unit,
wherein the detection rule includes one or more detection rules among a first detection rule that executes blind detection using, as a search space, a region that is indicated in advance by the base station through a high layer signaling, and a second detection rule that executes blind detection by changing a search space based on the aggregation level of the E-PDCCH.

14. The apparatus as claimed in claim 13, wherein the region indicated in advance of the first detection rule is one of the common region and the user equipment specific region; and
the controller controls the transceiving unit to receive, from the base station through the high layer signaling, information indicating that the E-PDCCH is mapped to a resource of one of the common region and the user equipment specific region.

15. The apparatus as claimed in claim 13, wherein the second detection rule executes blind detection using, as a search space, a resource mapped based on localized mapping when the aggregation level is less than k (k is a natural number greater than or equal to 2), and executes blind detection using, as a search space, a resource mapped based on distributed mapping when the aggregation level is greater than or equal to k.

16. The apparatus as claimed in claim 15, wherein, when the aggregation level is k, the second detection rule executes blind detection using, as a search space, both the resource mapped based on localized mapping and the resource mapped based on distributed mapping.
